(19) United States
(12) Patent Application Publication
(10) Pub. No.: US 2024/0259517 A1
(43) Pub. Date: Aug. 1, 2024

(54) VIDEO PROCESSING DEVICE, COMPUTER-READABLE RECORDING MEDIUM STORING VIDEO PROCESSING PROGRAM, AND VIDEO PROCESSING METHOD

(71) Applicant: Roland Corporation, Shizuoka (JP)

(72) Inventor: Yoshihide Kasai, Shizuoka (JP)

(73) Assignee: Roland Corporation, Shizuoka (JP)

(21) Appl. No.: 18/420,676

(22) Filed: Jan. 23, 2024

(30) Foreign Application Priority Data
Jan. 27, 2023 (JP) 2023-011147

(51) Int. Cl. H04N 5/268; H04N 5/262

(52) U.S. Cl. CPC H04N 5/268; H04N 5/2624

(57) ABSTRACT

A video processing device is provided. The video processing device outputs a composite video, wherein the composite video is a video in which a plurality of media data are disposed, the media data is formed by an image and/or a video, the video processing device comprises: a first output device, outputting the composite video; a second output device, outputting a composite video different from the composite video output by the first output device; at least one processor; and at least one display device, having a first display region and a second display region different from the first display region, wherein the at least one processor is configured to: perform display for setting the composite video output by the first output device in the first display region, and perform display for setting the composite video output by the second output device in the second display region.

### CROSS-REFERENCE TO RELATED APPLICATION

This application claims the priority benefit of Japan application no. 2023-011147, filed on Jan. 27, 2023. The entirety of the above-mentioned patent application is hereby incorporated by reference herein and made a part of this specification.

### BACKGROUND

### Technical Field

The invention relates to a video processing device, a computer-readable recording medium storing a video processing program, and a video processing method.

### Description of Related Art

Patent Document 1 discloses a video mixer having multiple video input channels, and outputting an output video in which input videos input from the respective video input channels are disposed. In addition, in the video mixer, multiple output terminals outputting videos are provided, and output videos are created from the input videos for each output terminal. In addition, the created output videos are respectively output to the corresponding output terminals.

### PRIOR ART DOCUMENT(S)

### Patent Document(s)

[Patent Document 1] Japanese Laid-open No. 2002-262179 (e.g., para. 0016 to 0019, 0037 and FIGS. 1 to 4 and 7).

However, in the video mixer, only one display 5A for setting the output video is provided. Therefore, in the case where the output video of one output terminal is being set, the output videos of other output terminals cannot be set. Thus, at the time of simultaneously setting output videos output to multiple output terminals, an issue that the user operability deteriorates, such as that the user cannot set the output video of one output terminal while viewing the output videos of other output terminals, may arise.

The invention provides a video processing device, a video processing program, and a video processing method capable of facilitating user operability at the time of outputting composite videos respectively different from each other to a first output device and a second output device.

### SUMMARY

A video processing device according to an aspect of the invention is a device that outputs a composite video of media data. The composite video is a video in which a plurality of media data are disposed. The media data is formed by an image and/or a video. The video processing device includes: a first output device, outputting the composite video; a second output device, outputting a composite video different from the composite video output by the first output device; at least one processor; and at least one display device, having a first display region and a second display region different from the first display region. The at least one processor is configured to: perform display for setting the composite video output by the first output device in the first display region, and perform display for setting the composite video output by the second output device in the second display region different from the first display region.

A computer-readable recording medium storing a video processing program according to another aspect of the invention is a computer-readable recording medium storing a program that causes a computer to execute a process for outputting a composite video. The computer includes a first output device, a second output device, and at least one display device. The composite video is a video in which a plurality of media data are disposed. The media data is formed by an image and/or a video. The at least one display device has a first display region and a second display region different from the first display region. The first output device outputs the composite video. The second output device outputs a composite video different from the composite video output by the first output device. The program causes the computer to: perform display for setting the composite video output by the first output device in the first display region, and perform display for setting the composite video output by the second output device in the second display region different from the first display region.

In addition, a video processing method according to yet another aspect of the invention is a method for outputting a composite video. The composite video is a video in which a plurality of media data are disposed. The media data is formed by an image and/or a video. The method includes: outputting the composite video by using a first output device; outputting a composite video different from the composite video output by the first output device by using a second output device; performing display for setting the composite video output by the first output device in a first display region; and performing display for setting the composite video output by the second output device in the second display region different from the first display region.

### BRIEF DESCRIPTION OF THE DRAWINGS

FIG. 1 is a view illustrating the appearance of a video switcher.

FIG. 2A is a view illustrating a setting screen displayed on an LCD, and FIG. 2B is a view illustrating a setting screen after scene information is changed.

FIG. 3A is a view illustrating a setting screen in a case where scene information for a distribution PC is changed, and FIG. 3B is a view illustrating a setting screen after the scene information is changed.

FIG. 4A is a view illustrating a setting screen in a case where the scene information is selected when different banks are set for a projector and for the distribution PC, and FIG. 4B is a view illustrating a setting screen after the scene information is changed.

FIG. 5 is a functional block diagram of the video switcher.

FIG. 6 is a block diagram illustrating an electrical configuration of the video switcher.

FIG. 7 is a view schematically illustrating bank data.

FIG. 8 is a flowchart of a main process.

FIG. 9A is a flowchart illustrating a preview display process, and FIG. 9B is a flowchart illustrating a PGM output process.

### DESCRIPTION OF THE EMBODIMENTS

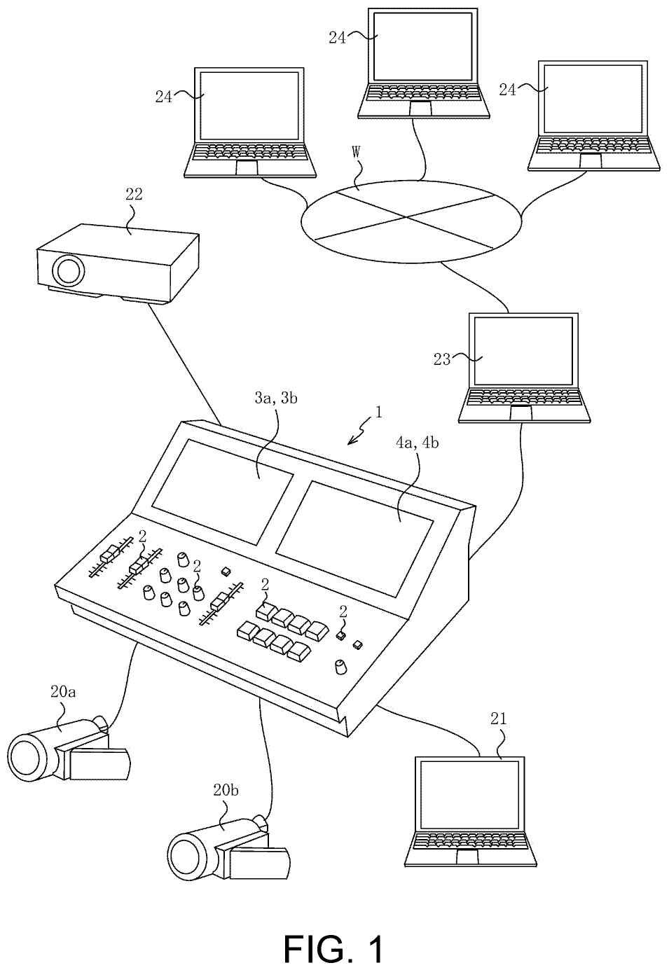

In the following, the exemplary embodiments will be described with reference to the accompanying drawings. The outline of a video switcher 1 according to the embodiment is described with reference to FIG. 1. FIG. 1 is a view schematically illustrating the video switcher 1. The video switcher 1 is a device (video processing device) that outputs a composite video Sc in which input images or videos are disposed in one video.

The video switcher 1 is connected with video cameras 20a, 20b and a presentation PC 21 where images or videos disposed in the composite video Sc are input and a projector 22 and a distribution PC 23 where the composite video Sc is output. The video cameras 20a, 20b are image capturing devices inputting captured images or videos to the video switcher 1. The presentation PC 21 is an information processing device that inputs an image or a video created by a user H by using installed application software to the video switcher 1.

The projector 22 is an output device that projects the composite video Sc from the video switcher 1 onto a large screen. The distribution PC 23 is an information processing device that distributes the composite video Sc output from the video switcher 1 via an Internet W. The composite video Sc distributed from the distribution PC via the Internet W can be viewed by using multiple distribution destination PCs 24 connected to the Internet W. It may also be that the video switcher 1 is connected with the Internet W and directly distributes the composite video Sc from the video switcher 1 to the distribution destination PCs 24. In such case, the distribution PC 23 can be omitted.

In the video switcher 1, for each input source, i.e., each of the video cameras 20a, 20b and the presentation PC 21, a “layer” in which the images or videos input from the corresponding input source are disposed is provided. In each layer, the images or videos input from the corresponding input source are disposed in a size and at a location designated by the user H. By superimposing such layers, the composite video Sc is created. In the following, the images or videos disposed in the layers are generally referred to as “media data”.

In the video switcher 1, a setting button 2 inputting an instruction of the user H, a left touch panel 3a and a left LCD 3b, and a right touch panel 4a and a right LCD 4b are provided. The left touch panel 3a is an input device for inputting a signal related to a touched position in accordance with a touch operation performed by the user H. The left LCD 3b is a display device displaying a layout, etc., of the composite video Sc that is output. The left touch panel 3a and the left LCD 3b are respectively disposed on the left side in the front surface of the video switcher 1, and the left touch panel 3a is provided to be superimposed on the left LCD 3b.

Likewise, the right touch panel 4a is an input device for inputting a signal related to a touched position in accordance with a touch operation performed by the user H, and the right LCD 4b is a display device displaying a layout, etc., of the composite video Sc that is output. The right touch panel 4a and the right LCD 4b are respectively disposed on the right side in the front surface of the video switcher 1, and the right touch panel 4a is provided to be superimposed on the right LCD 4b.

In the video switcher 1 of the embodiment, it is configured that respectively different composite videos Sc can be output to the projector 22 and the distribution PC 23. On the left LCD 3b, a screen for setting the composite video Sc output to the projector 22 is displayed, and on the right LCD 4b, a screen for setting the composite video Sc output to the distribution PC 23 is displayed.

By performing touch operations on the touch panels 3a, 4a disposed on the LCDs 3b, 4b while comparing the layouts of the composite videos Sc respectively displayed on the LCDs 3b and 4b, the user H can freely set the size and the arrangement of the media data in the composite videos Sc and construct the composite videos Sc with desired layouts. Accordingly, the operability of the user H can be facilitated at the time of outputting the respectively different composite videos Sc to the projector 22 and the distribution PC 23.

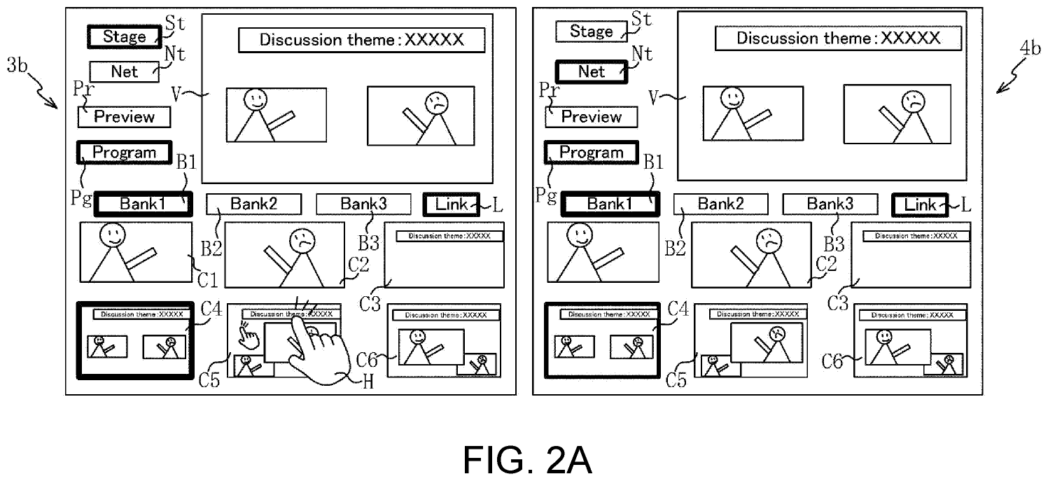

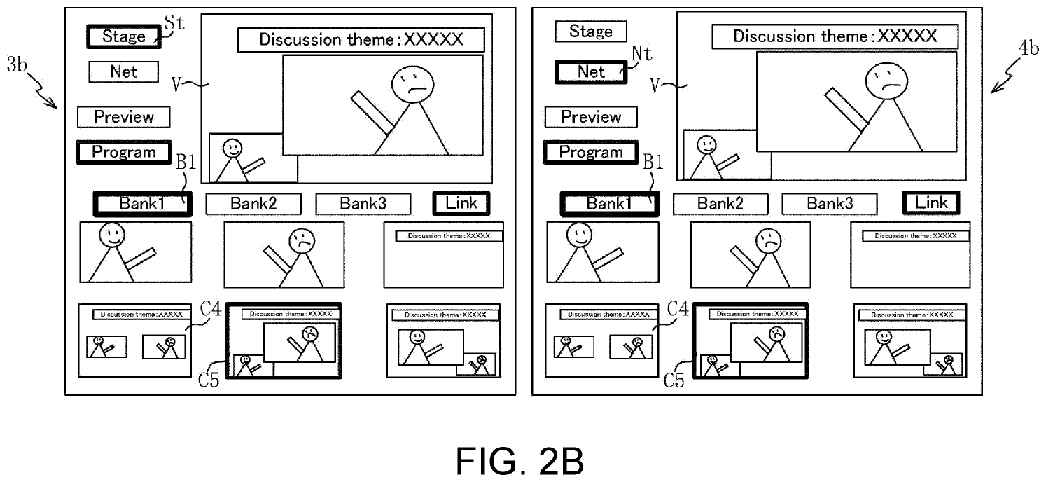

Then, with reference to FIGS. 2A to 4B, the setting screens at the time of setting the composite videos Sc displayed on the LCDs 3b, 4b are described. FIG. 2A is a view illustrating setting screens displayed on the LCDs 3b, 4b, and FIG. 2B is a view illustrating setting screens after scene information is changed. In FIGS. 2A and 2B, the setting screen displayed on the left LCD 3b is displayed on the left side, and the setting screen displayed on the right LCD 4b is displayed on the right side. The same applies to the subsequent drawings.

On each of the setting screens displayed on the LCDs 3b, 4b, a display area V, a stage distribution button St and a net distribution button Nt, a preview output button Pr and a program output button Pg, preview buttons C1 to C6, bank buttons B1 to B3, and a link button L are displayed. The display area V is a display area that displays the composite video Sc as a target.

The stage distribution button St is an operator that sets an output destination (e.g., disposed to project on a screen on a stage of a concert venue) of the target composite video Sc to the projector 22. The net distribution button Nt is an operator that sets the output destination of the target composite video Sc to the distribution PC 23 via the Internet W. It is configured that any one of the stage distribution button St and the net distribution button Nt is selectable.

The preview output button Pr is an operator that sets the setting mode to “preview output”, and the program output button Pg is an operator that sets the setting mode to “program output”. It is configured that any one of the preview output button Pr and the program output button Pg is selectable.

In the embodiment, in the setting mode of the video switcher 1, “preview output”, which is a mode that sets the configuration of the composite video Sc without outputting the target composite video Sc to the projector 22 or the distribution PC 23, and “program output”, which outputs the target composite video Sc to the projector 22 or the distribution PC 23, are provided. In addition, the setting mode in the embodiment is configured to be independently settable on each of the left LCD 3b and the right LCD 4b.

For example, in the left LCD 3b of FIG. 2A, the program output button Pg is selected, and the stage distribution button St is selected. Therefore, the composite video Sc displayed on the display area V of the left LCD 3b is also output to the projector 22. In addition, in the right LCD 4b of FIG. 2A, the program output button Pg is selected, and the net distribution button Nt is selected. Therefore, the composite video Sc displayed on the display area V of the right LCD 4b is also output to the distribution PC 23.

In the following, in the embodiment, on the left LCD 3b, the program output button Pg and the stage distribution button St are selected, and on the right LCD 4b, the program output button Pg and the net distribution button Nt are selected.

The preview buttons C1 to C6 are operators that select scene information for creating the composite video Sc displayed on the display area V and output to the projector 22 or the distribution PC. It is configured that any one of the preview buttons C1 to C6 is selectable. In the video switcher 1 of the embodiment, scene information, which is the information for constructing the composite video Sc from the images or videos input from the video cameras 20a, 20b and the presentation PC 21, is stored. Information such as the size and the arrangement position of the input images or videos at the time of constructing the composite video Sc is set in the scene information.

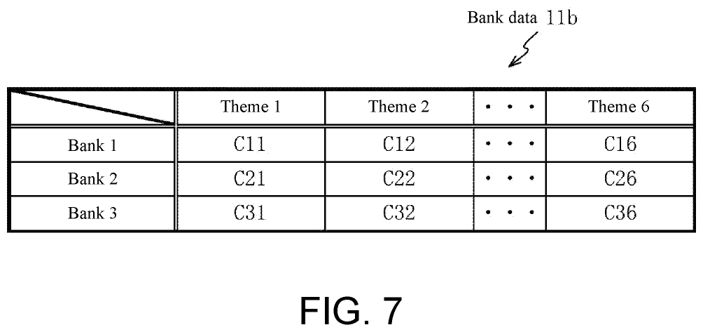

Six pieces of scene information are stored in a region referred to as a bank. In addition, in the video switcher 1, three banks are provided. Therefore, 18 pieces of scene information are stored in the video switcher 1 (see FIG. 7). In the bank, the scene information is stored in order. Scene information of a similar manner, that is, scene information in which images or videos are disposed similarly, are stored in scene information of the same order in each bank. For example, scene information of a similar manner is respectively stored in the first scene information of “bank 1”, which is the first bank, and the first scene information of “bank 2”, which is the second bank.

While details will be described in the following, in the embodiment, the scene information of the distribution PC 23 is changed in association with a change of the scene information of the projector 22. The change of the scene information is carried out by obtaining the scene information of a specified order from the bank. Therefore, in the bank used by the projector 22 and the bank used by the distribution PC 23, scene information in a similar manner is respectively stored in the same order, and the scene information of the same order as the order designated in the change of the scene information of the projector 22 is obtained from the bank used by the distribution PC 23. Accordingly, in association with the change of the scene information of the projector 22, the scene information of the distribution PC 23 can be changed to scene information in a similar manner in correspondence with the scene information of the projector 22 that is changed.

Nevertheless, it may also be that scene information of respectively different manners is stored in the scene information of the same order in the respective banks.

In the following, the number assigned to each scene information in the bank is referred to as “theme number”. The preview button C1 corresponds to the scene information with the theme number “1”, that is, the scene information stored in the first place of the bank that is set. The preview button C2 corresponds to the scene information with the theme number “2”. Likewise, the preview buttons C3 to C6 respectively correspond to the scene information whose theme numbers are “3” to “6”.

Nevertheless, in the embodiment, the number of pieces of scene information stored in the bank is not limited to six, but may also be six or more or six or less. In addition, the banks provided in the video switcher 1 is not limited to three, but may also be three or more or three or less.

In the preview buttons C1 to C6, the composite videos Sc created from the scene information stored in the bank selected by the bank button B1 to B3 to be described afterwards are displayed as “thumbnails”. In the embodiment, six pieces of scene information are stored in the bank. Therefore, the composite videos Sc created by using the respective scene information are displayed on the preview buttons C1 to C6.

The bank buttons B1 to B3 are operators selecting which bank to use among the banks stored in the video switcher 1. It is also configured that any one of the bank buttons B1 to B3 is selectable.

The link button L is an operator selecting whether, in the case where the preview button C1 to C6 is operated in one of the LCDs 3b, 4b to change the scene information that is applied, the scene information applied to the output destination displayed by the other of the LCDs 3b, 4b is changed. In the embodiment, the selection status of the link button L is shared in the respective LCDs 3b, 4b.

For example, in the case where the link button L is turned ON in the left LCD 3b, the link button L also becomes ON in the right LCD 4b, and in the case where the link button L is turned OFF in the right LCD 4b, the link button L also becomes OFF in the left LCD 3b. In the following, the case where the link button L is turned ON is described in FIGS. 2A to 4B.

In the embodiment, in the case where one of the preview buttons C1 to C6 is selected in one of the LCDs 3b, 4b in which the link button L is turned ON, the stage distribution button St is selected, and the projector 22 is selected as the output destination, the preview button C1 to C6 corresponding to the same theme number is also selected in the other of the LCDs 3b, 4b in which the network distribution button Nt is selected, and the distribution PC 23 is selected as the output destination.

More specifically, in the state in which the preview button C4 is selected in each of the LCDs 3b, 4b in FIG. 2A, in the left LCD 3b whose output destination is the projector 22, if the user H selects the preview button C5, the preview button C5 is selected in the left LCD 3b, as shown in FIG. 2B. Together with this, the scene information creating the composite video Sc output to the projector 22 (simply referred to as “scene information of the projector 22) is changed to the theme number “5”. Meanwhile, in the right LCD 4b whose output destination is the distribution PC 23 as well, the preview button C5 is selected, and the scene information of the distribution PC 23 is also changed to the theme number “5”.

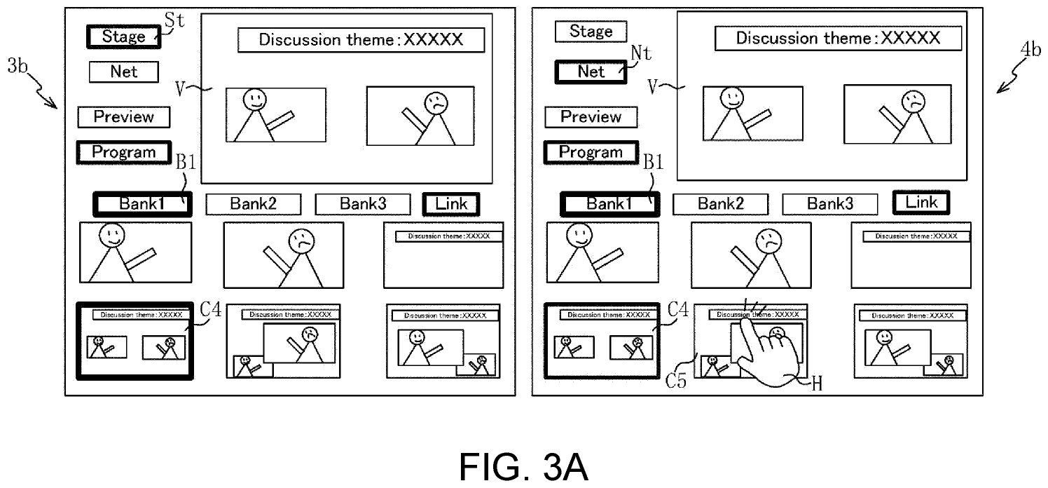

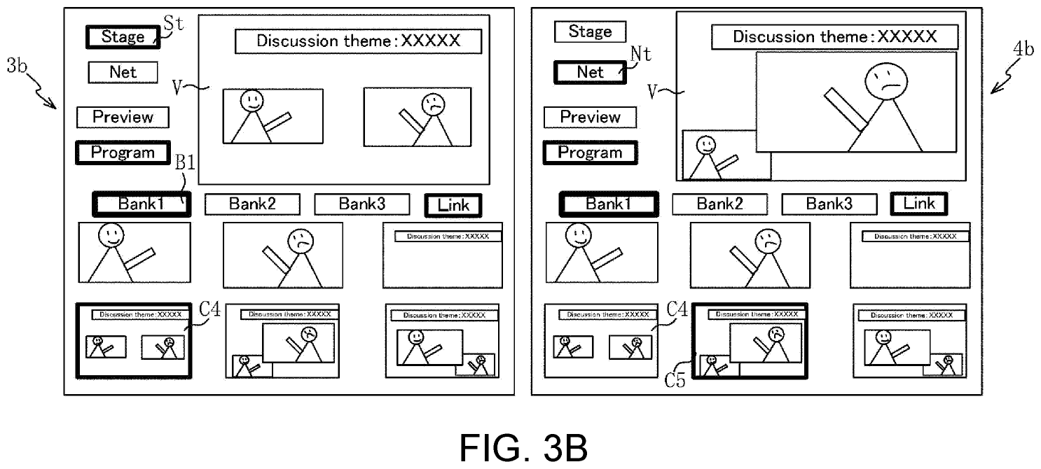

Then, the case where the scene information for the distribution PC 23 is changed is described with reference to FIGS. 3A and 3B. FIG. 3A is a view illustrating a setting screen in the case where the scene information for the distribution PC 23 is changed, and FIG. 3B is a view illustrating the setting screen after the scene information is changed.

In the state in which the preview button C4 is selected in each of the LCDs 3b, 4b in FIG. 3A, in the right LCD 4b, if the user H operates to select the preview button C5, the preview button C5 is selected in the right LCD 4b, as shown in FIG. 3B. Together with this, the scene information of the distribution PC 23 is changed to the theme number “5”.

However, despite the change of the scene information in the right LCD 4b, in the left LCD 3b, the preview button C4 is still selected, and the theme number is maintained as “4” in the scene information of the projector 22.

In this way, by changing the scene information of the distribution PC 23 in association with the change of the scene information of the projector 22, the operability of the user H is facilitated in the case where the scene information of the two output destinations are changed at the same time. In addition, the scene information of the distribution PC 23 that is changed in association can be changed to the scene information same as the scene information of the projector 22 that is changed.

Meanwhile, even if the scene information of the distribution PC 23 is changed, the scene information of the projector 22 is maintained. That is, the scene information of the projector 22 is not changed in association with the scene information of the distribution PC 23.

For example, at the time when the projector 22 is disposed to project on a large screen on a stage in a concert venue, the stage is shot by using the video cameras 20a, 20b and the situation is output to the projector 22 and the distribution PC 23 as the composite video Sc, even if the video cameras 20a, 20b fail and cannot obtain media data, the viewers of the large screen to which the projector 22 projects can directly see the situation of the stage. Therefore, even if the media data from the video cameras 20a, 20b in the composite video Sc displayed on the large screen is a black screen (no signal screen), the problem is usually small.

Comparatively, the viewers of the distribution PC 23 cannot directly see the situation of the stage and are therefore unable to determine how the situation is on the stage. It is necessary to output a composite video Sc including a message indicating that media data cannot be obtained from the video cameras 20a to 20b to the distribution PC 23.

Therefore, by making the scene information of the distribution PC 23 the scene information in a manner including such message, the viewers of the distribution PC 23 can be notified that media data cannot be obtained from the video cameras 20a, 20b. Meanwhile, since the scene information of the projector 22 is not changed in association to such scene information of the distribution PC 23, a message that is not required can be suppressed from being transmitted to the viewers of the large screen.

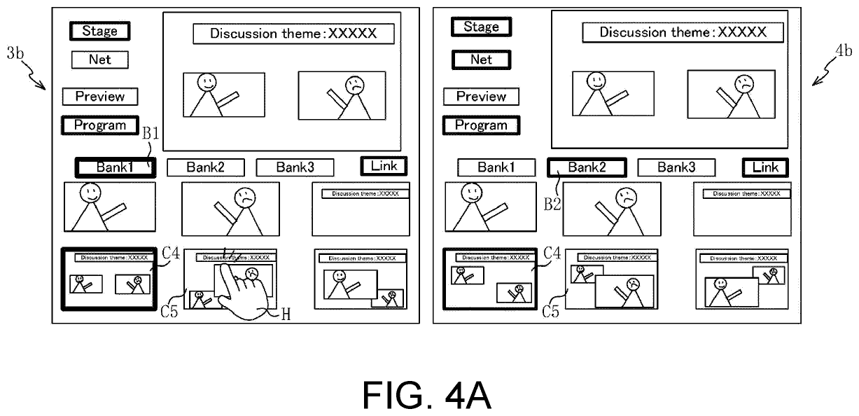

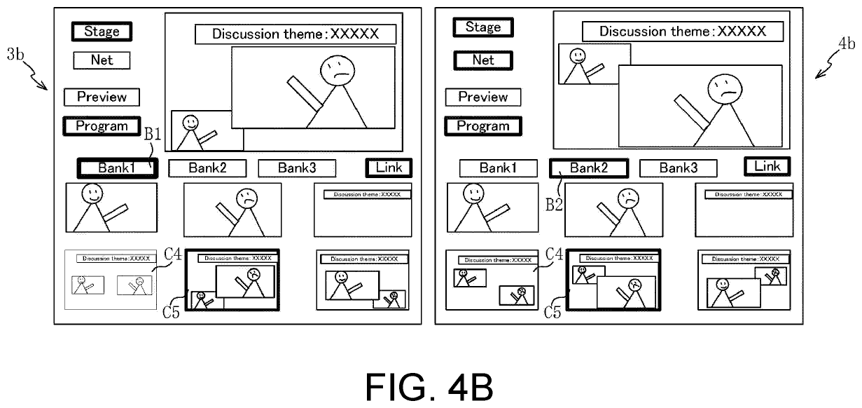

FIGS. 2A and 2B and 3A and 3B describe the case where the scene information of the same bank is set in the projector 22 and the distribution PC 23. However, even in the case where the scene information of different banks is respectively set in the projector 22 and the distribution PC 23, the scene information of the distribution PC 23 is changed in association with the change of the scene information of the projector 22. Such operation is described with reference to FIGS. 4A and 4B.

FIG. 4A is a view illustrating a setting screen in the case where the scene information is selected when different banks are set for the projector 22 and the distribution PC 23, and FIG. 4B is a view illustrating a setting screen after the scene information is changed. In FIGS. 4A and 4B, the bank button B1 is selected in the left LCD 3b, and the bank button B2 is selected in the right LCD 4b.

In the case where the user H operates to select the preview button C5 in the left LCD 3b in the state in which the banks are selected, and the preview button C4 is selected for the LCDs 3b, 4b, respectively, as shown in FIG. 4A, the preview button C5 is selected in the left LCD 3b, and the scene information of the projector 22 is changed to the theme number “5”, as shown in FIG. 4B. Accordingly, the scene information of the projector 22 is changed to the theme number “5” of “bank 1”.

Meanwhile, in the right LCD 4b as well, in association with the change of the scene information of the projector 22, the preview button C5 is selected, and the scene information of the distribution PC 23 is also changed to the theme number “5”. Accordingly, the scene information of the distribution PC 23 is changed to the theme number “5” of “bank 2”.

According to the above, in the respective banks, scene information in a similar manner, that is, scene information having similar arrangements of images or videos, is stored in scene information of the same order. For example, in the case where scene information specific to the projector 22 is stored in “bank 1”, and scene information specific to the distribution PC 23 is stored in “bank 2”, scene information in a similar manner is respectively stored in the same theme number in these banks.

Therefore, the bank specific to the projector 22 is set as the bank of the projector 22, and the bank specific to the distribution PC 23 is set as the bank of the distribution PC 23. By doing so, when the scene information of the projector 22 is changed, the scene information which is specific to the projector 22 and desired by the user H is set to be the scene information of the projector 22. Together with this, the scene information specific to the distribution PC 23 and in a manner similar to the scene information desired by the user is set to be the scene information of the distribution PC 23.

Accordingly, the corresponding scene information that is desired by the user H while being specific to the respective output destinations is set as the scene information of both of the projector 22 and the distribution PC 23. Therefore, the operability of the user H can be facilitated in the case where the scene information of the two output destinations are changed at the same time.

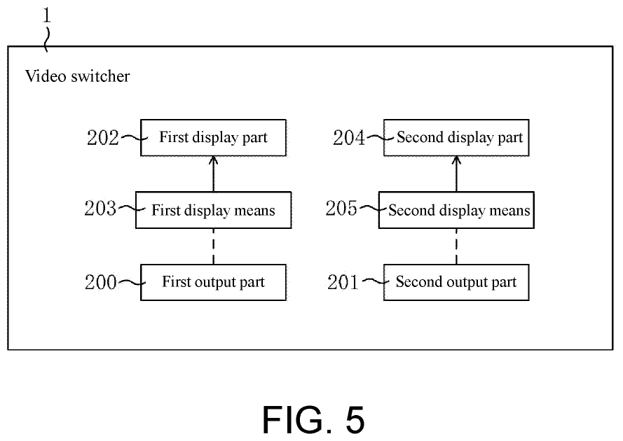

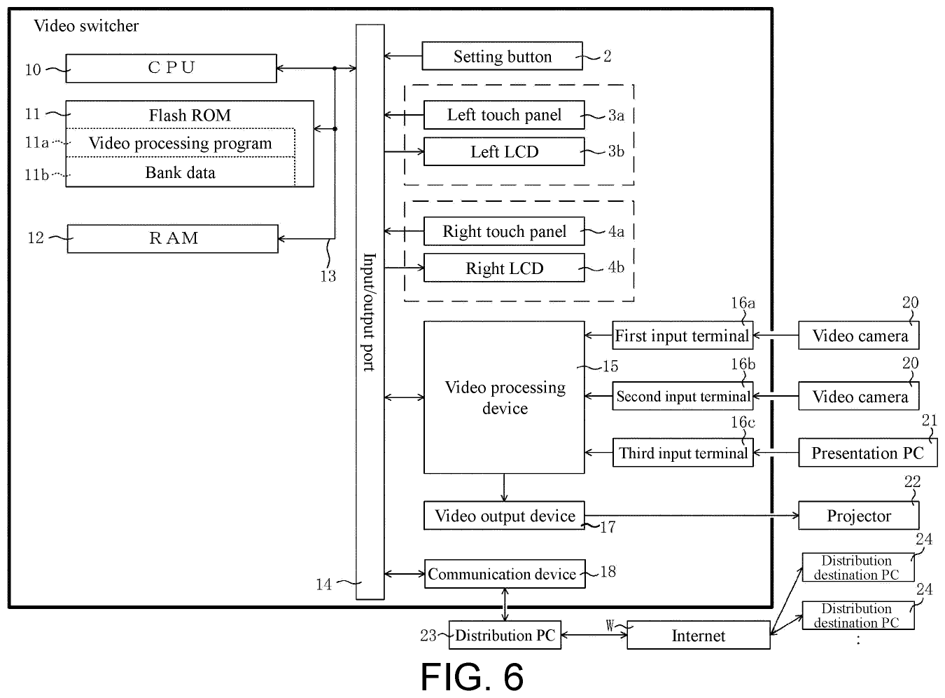

Then, the functions of the video switcher 1 are described with reference to FIG. 5. FIG. 5 is a functional block diagram of the video switcher 1. As shown in FIG. 5, the video switcher 1 has a first output device 200, a second output device 201, a first display means 203, and a second display means 205. The first output device 200 outputs the composite video, and is realized by a video output device 17 to be described afterwards with reference to FIG. 6. The second output device 201 outputs a composite video different from the composite video output by the first output device 200, and is realized by a communication device 18 to be described afterwards with reference to FIG. 6.

The first display means 203 is a means for performing display for setting the composite video output by the first output device 200 on a display part 202, and is realized by using a CPU 10 to be described afterwards. The first display part 202 is realized by the left LCD 3b. The second display means 205 is a means for performing display for setting the composite video output by the second output device 201 on a second display part 204 different from the first display part 202, and is realized by the CPU 10. The second display part 204 is realized by the right LCD 4b. In addition, a portion or the entirety of the first display means 203 and the second display means 205 may also be realized by a video processing device 15 and the video output device 17 to be described afterwards in FIG. 6.

With such configuration, the user H of the video switcher 1 can set the composite video output by the first output device 200 and the composite video output by the second output device 200 while comparing the composite videos by using the first display part 202 and the second display part 204, respectively. Therefore, the operability of the user H at the time when respectively different composite videos are output to the first output device 200 and the second output device 201 can be facilitated.

Then, the electrical configuration of the video switcher 1 is described with reference to FIG. 6. FIG. 6 is a block diagram illustrating an electrical configuration of the video switcher 1. As shown in FIG. 6, the video switcher 1 includes the CPU 10, a flash ROM 11, and a RAM 12. In addition, the CPU 10, the flash ROM 11, and the RAM 12 are respectively connected with an input/output port 14 via a bus line 13. The input/output port 14 is further connected with the setting button 2, the left touch panel 3a, the left LCD 3b, the right touch panel 4b and the right LCD 4b, the video processing device 15, and the communication device 18.

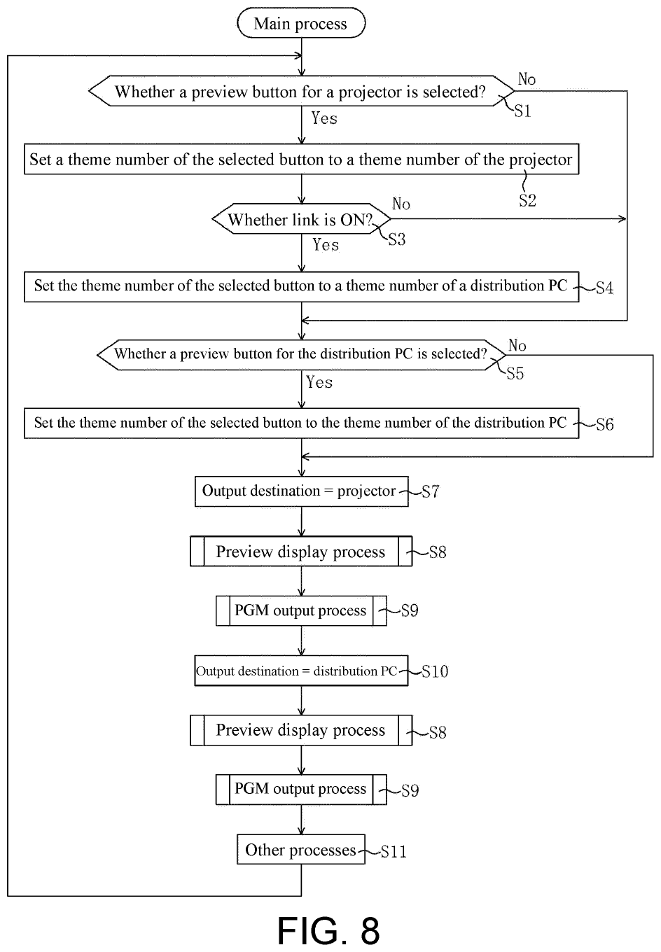

The CPU 10 is a computational device that controls the respective parts through the bus line 13. The flash ROM 11 is a rewritable non-volatile storage device storing the programs executed by the CPU 10 and fixed value data, etc., and stores a video processing program 11a, and a bank data 11b. When the video processing program 11a is executed by the CPU 10, a main process shown in FIG. 8 is executed. Here, the bank data 11b is described with reference to FIG. 7.

FIG. 7 is a view schematically illustrating the bank data 11b. In the bank data 11 b, multiple pieces of scene information are stored with respect to multiple banks. In the bank 1, scene information C11, C12, . . . , C16 is stored for each theme number (theme 1, theme 2, . . . , theme 6). Likewise, in the bank 2, scene information C21, . . . , C26 is stored for each theme number. In the bank 3, scene information C31, . . . , C36 is stored for each theme number for each theme number. In the embodiment, the scene information is configured so that the user H can change the setting, and the bank data 11b is configured so that the scene information in which the setting is changed by the user H is rewritable.

Referring to FIG. 6 again, The RAM 12 is a memory for rewritably storing various work data and flags, etc., when the CPU 10 executes the program. The video processing device 15 is a computational device performing image processing in accordance with an instruction from the CPU 10. A first input terminal 16a to a third input terminal 16c inputting images or videos for performing an image process by using the video processing device 15 and a video output device 17 that outputs images or videos of the composite video Sc on which the image process is performed by the video processing device 15 are connected with the video processing device 15.

The video camera 20a, the video camera 20b, and the presentation PC 21 are connected with the first input terminal 16a to the third input terminal 16c, and the images or videos from the video camera 20a, the video camera 20b, and the PC 21 are input to the video processing device 15 via the first input terminal 16a to the third input terminal 16c. In addition, the projector 22 is connected with a video output device 16, and the corresponding videos are output to the projector 22 via the video output device 16. It is noted that, at least a portion of the video processing device 15 or the video output device 17 may be configured by using an electronic circuit, such as a field-programmable gate array (FPGA) or a dedicated LSI.

The communication device 18 is a device for communication with an external device, and, in particular, is connected to be able to communicate with the distribution PC 23. The distribution PC 23 is connected with the Internet W, and the Internet W is connected with the distribution destination PC 24.

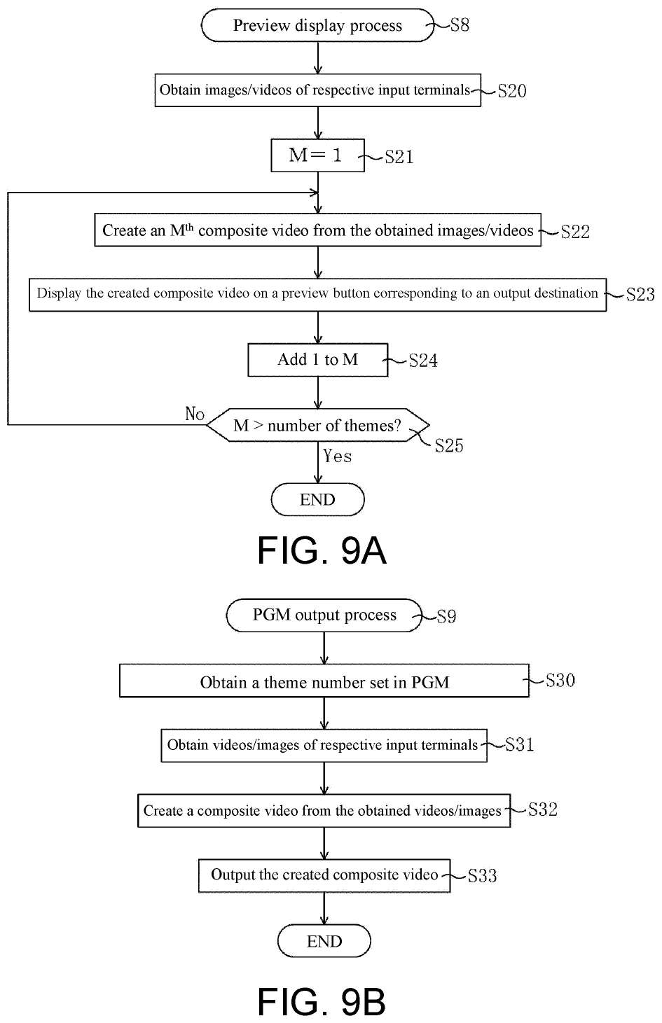

Then, the processes executed by the CPU 10 of the video switcher 1 are described with reference to FIGS. 8 and 9. FIG. 8 is a flowchart of a main process. The main process is a process that is executed in the case where the power of the video switcher 1 is turned on.

In the main process, firstly, whether the preview button C1 to C6 for the projector 22 (displayed on the left LCD 3b) is selected is confirmed (Si). In the case where the preview button C1 to C6 for the projector 22 is selected in the process of Si (Si: Yes), the theme number assigned to the selected preview button C1 to C6 is set to be the theme number of the projector 22 (S2).

After the process of S2, whether the link button L is turned ON is confirmed (S3). In the case where the link button L is turned ON in the process of S3, the theme number assigned to the selected preview button C1 to C6 is set to the theme number of the distribution PC 23 (S4).

Meanwhile, in the case where the preview buttons C1 to C6 for the projector 22 are not selected in the process of S1 (S1: No), the processes of S2 to S4 are skipped. In addition, in the case where the link button L is turned OFF in (S3: No) in the process of S3, the process of S4 is skipped.

After the processes of Si, S3, and S4, whether the preview button C1 to C6 for the distribution PC 23 (displayed on the right LCD 4b) is selected is confirmed (S5). In the case where the preview button C1 to C6 for the distribution PC 23 is selected in the process of S5 (S5: Yes), the theme number assigned to the selected preview button C1 to C6 is set to be the theme number of the projector 23 (S2). Meanwhile, in the case where the preview buttons C1 to C6 for the distribution PC 23 are not selected in the process of S1 (S1: No), the process of S6 is skipped.

After the processes of S5, S6, the output destination that is referred to in a preview display process of S8 and a PGM output process of S9 to be described afterwards is set to “projector 22” (S7). After the process of S7, the preview display process of S8 and the PGM output process of S9 are executed. Here, the preview display process and the PGM output process are described with reference to FIGS. 9A and 9B.

FIG. 9A is a flowchart illustrating the preview display process. The preview display process is a process that displays the composite video Sc in the preview buttons C1 to C6 of the LCD 3b, 4b corresponding to the output destination. In the preview display process, firstly, media data (image or video) are obtained from the first input terminal 16a, the second input terminal 16b, and the third input terminal 16c (S20). After the process of S20, a counter variable M is set to 1 (S21).

After the process of S21, from the bank data 11b, the scene information whose theme number in the bank selected by the bank button B1 to B3 of the corresponding LCD 3b, 4b is M^{th} is obtained, and the composite video Sc is created from the obtained scene information and the media data obtained in the process of S20 (S22). Specifically, by disposing the media data obtained in the process of S20 in the size and at the arrangement position of the media data set in the scene information that is obtained, the composite video Sc is created.

After the process of S22, the created composite video Sc is displayed on the preview button C1 to C6 of the LCD 3b, 4b corresponding to the output destination (S23). For example, in the case where the counter variable M is “1”, the composite video Sc created in the process of S23 is displayed on the preview button C1, and in the case where the counter variable is “6”, the composite video Sc created in the process of S23 is displayed on the preview button C6.

After the process of S23, the counter variable M is added by 1 (S24), and whether the counter variable M after the addition is greater than the number (i.e., “6”) of pieces of the scene information is confirmed (S25) In the process of S25, in the case where the counter variable M is less than or equal to the number of the scene information, the processes from S22 are repeated. Meanwhile, in the case where the counter variable M is greater than the number of the scene information (S25: Yes), the preview display process is ended.

Then, with reference to FIG. 9B, the PGM output process is described. FIG. 9B is a flowchart illustrating the PGM output process. The PGM output process is a process that creates the composite video Sc from the scene information set in the output destination and outputs the composite video Sc to the display area V of the LCD 3b, 4b corresponding to the output destination and the output destination.

In the PGM output process, firstly, the theme number corresponding to the selected preview button C1 to C6 in the corresponding LCD 3b, 4b is obtained (S30). After the process of S30, media data (image or video) are obtained from the first input terminal 16a, the second input terminal 16b, and the third input terminal 16c, respectively (S31).

After the process of S31, from the bank data 11b, the scene information of the theme number obtained in the process of S30 and in the bank selected by the bank button B1 to B3 of the corresponding LCD 3b, 4b is obtained, and the composite video Sc is created from the obtained scene information and the media data obtained in the process of S31 (S32). After the process of S32, the composite video Sc that is created is displayed on the display area V of the LCD 3b, 4b corresponding to the output destination and is output to the output destination (i.e., the projector 22 or the distribution PC 23). The composite video Sc output to the distribution PC 23 through the process of S33 is distributed from the distribution PC 23 to the distribution destination PC 24 via the Internet W. After the process of S33, the PGM output process is ended.

Referring to FIG. 8 again, after the PGM output process of S9, the “distribution PC 23” is set as the output destination (S10), and the preview display process of S8 and the PGM output process of S9 are executed. After the PGM output process of S9, other processes of the video switcher 1 are executed (S11), and the processes from S1 are repeated.

According to the above, description is made based on the embodiment. However, it can be easily inferred that various improvements and changes are possible.

In the embodiment, the scene information of the distribution PC 23 is changed in association with the change of the scene information of the projector 22. However, the invention is not limited thereto. It may also be that the scene information of the projector 22 is changed in association with the change of the scene information of the distribution PC 23. In such case, by changing the scene information of the distribution PC 23 in association with the change of the scene information of the projector 22, the change of the scene information of the projector 22 and the change of the scene information of the PC 23 may be associated in both directions, and it may also be that even if the scene information of the projector 22 is changed, the scene information of the distribution PC 23 remains the same (it may also be that the scene information of the distribution PC 23 is not changed).

In the embodiment, no matter which of the preview buttons C1 to C6 corresponding to the projector 22 is selected, the scene information of the distribution PC is changed in association. However, the invention is not limited thereto. It may also be that, in the preview buttons C1 to C6 corresponding to the projector 22, the preview buttons C1 to C6 changed in association with the scene information of the distribution PC 23 and the preview buttons C1 to C6 not changed in association are mixed.

For example, it may also be that, when the preview button C1, C3, C5 corresponding to the projector 22 is selected, the scene information of the distribution PC 23 is changed in association, whereas even if the preview button C2, C4, C6 corresponding to the projector 22 is selected, the scene information of the distribution PC 23 is not changed.

Moreover, it may also be that, in the banks stored in the bank data 11b and corresponding to the bank buttons B1 to B3, a bank in which the scene information of the distribution PC 23 is changed in association in the case where the scene information of the projector 22 is changed and a bank in which the scene information of the distribution PC 23 is not changed even if the scene information of the projector 22 is changed are mixed.

For example, it may also be that the scene information of the distribution PC 23 is changed in association with the change of the scene information of the projector 22 in the case where the bank button B2 corresponding to the projector 22 is selected, whereas the scene information of the distribution PC 23 is not changed even if the scene information of the projector 22 is changed in the case where the bank button B1, B3 corresponding to the projector 22 is selected.

In the embodiment, the stage distribution button St, the net distribution button Nt, the preview output button Pr, and the program output button Pg are provided in each of the LCDs 3b, 4b. However, the invention is not limited thereto. For example, the display of the stage distribution button St and the net distribution button Nt may be omitted from the LCDs 3b, 4b. In this case, for example, the output destination of the composite video Sc of the left LCD 3b may be fixedly set to the “projector 22”, and the output destination of the composite video Sc of the right LCD is fixedly set to the “distribution PC 23”, and it may also be that the output destination of the composite video Sc of the left LCD 3b is fixedly set to the “distribution PC 23”, and the output destination of the composite video Sc of the right LCD 4b is fixedly set to the “projector 22”. Alternatively, it may also be that the output destinations of the composite videos Sc of both of the LCDs 3b, 4b are fixedly set to the “projector 22” or fixedly set to the “distribution PC 23”.

Moreover, it may also be that the preview output button Pr and the program output button Pg are omitted from the LCDs 3b, 4b. In such case, for example, the setting mode of the left LCD 3b is fixedly set to “preview output”, and the setting mode of the right LCD 4b is fixedly set to “program output”.

It may also be that the setting mode of the left LCD 3b is fixed to “program output”, and the setting mode of the right LCD 4b is fixed to “preview output”. Alternatively, it may also be that the setting modes of both of the LCDs 3b, 4b are fixedly set to “preview output” or fixedly set to “program output”.

In the embodiment, it is configured that the scene information of the projector 22 and the scene information of the distribution PC 23 are changed in association by using one video switcher 1. However, the device configuration is not limited thereto. For example, it may also be that two video switchers disposed remotely are configured to be able to communicate with each other through the communication devices 18 via the Internet W, and one of the two video switchers (referred to as “first video switcher” in the following) serves to change the scene information of the projector 22, and the other video switcher (referred to as “second video switcher” in the following) serves to change the scene information of the distributed PC 23.

In addition, in the case where the scene information is changed in the first video switcher, the scene information of the second video switcher may also be changed in association with the change of the scene information in the first video switcher. In such case, the bank data 11b storing the same scene information may be provided in the first video switcher and the second video switcher.

In the embodiment, the projector 22 is set as the output destination corresponding to the left LCD 3b, and the distribution PC 23 is set as the output destination corresponding to the right LCD 4b. However, the invention is not limited thereto. For example, it may also be that the distribution PC 23 is set as the output destination corresponding to the left LCD 3b, and the projector 22 is set as the output destination corresponding to the right LCD 4b.

In the embodiment, the images or videos are input to the video switcher 1 by using the video camera 20a, the video camera 20b, and the presentation PC 21. However, the invention is not limited thereto. For example, images or videos may also be input from other devices such as a hard disk recorder or a gaming console. In addition, images or videos may also be input from the Internet W, etc., via the communication device 18. Alternatively, images or videos stored in advance in the flash ROM 11 of the video switcher 1 may also be used. In this way, images or videos input from the outside may also be stored in the flash ROM 11 of the video switcher 1.

Furthermore, in the embodiment, the input sources inputting images or videos to the video switcher 1 are set to be of three types, i.e., the video cameras 20a, 20b, and the presentation PC 21. However, the invention is not limited thereto. There may be three or less or three or more types of input sources. For example, images or videos may also be input from the two video cameras 20a, 20b, one presentation PC 21, one game console, and the Internet W.

In addition, the output destination to which the composite video Sc is output from the video switcher 1 is not limited to the projector 22 and the distribution PC 23. For example, the composite video Sc may also be output to other devices, such as a television connected with the first input terminal 16a, etc., of the video switcher 1, a smartphone connected via the Internet W, etc.

Furthermore, in the embodiment, although the output destinations of the composite video Sc from the video switcher 1 are of two types, i.e., the projector 22 and the distribution PC 23, the invention is not limited thereto. The output destination may be of two types or less or two types or more. For example, the composite video Sc may also be output to two projectors 22, one television, and the distribution PC 23.

In the embodiment, the Internet W is set as the network to which the distribution PC 23 and the distribution destination PC 24 are connected. However, the invention is not limited thereto. For example, the distribution destination PC 24 that is connected may also be in a limited intranet, and may also be any network constructed by using any other arbitrary communication systems.

In the embodiment, the video switcher 1 is provided with the combination of two touch panels and LCDs, i.e., the left touch panel 3a and the left LCD 3b as well as the right touch panel 4a and the right LCD 4b. However, the invention is not limited thereto. There may also be a combination of three or more touch panels and LCDs provided in the video switcher 1. Alternatively, it may also be that the video switcher 1 is provided with one combination of the touch panel and the LCD, the region of the one combination of the touch panel and the LCD is divided into two or more, and the setting mode and the output destination are designated for each divided region to perform setting, etc., of the composite videos Sc.

In addition, although the stage distribution button St, the net distribution button Nt, the preview output button Pr, the program output button Pg, and the bank button B1 to B3 are operators displayed on the LCDs 3b, 4b, the invention is not limited thereto. Some or all of the operators may also be configured as physical operators, such as the setting button 2.

In the embodiment, the video switcher 1 is shown as a device executing the video processing program 11a. However, the invention is not limited thereto. For example, the video processing program 11a may also be executed by an information processing device, such as a PC, a smartphone, a tablet terminal.

An example of the technical meaning of the matters described in the embodiment is as follows. The video switcher 1 is an example of the video processing device. The left touch panel 3a and the right touch panel 4a are an example of the first input device and the second input device. The left LCD 3b and the right LCD 4b are an example of the first display region and the second display region of the at least one display device. The flash ROM 11 is an example of a memory as the storage part. The video output device 17 is an example of the first output device. The communication device 18 is an example of the second output device.

In the embodiment, Steps S1, S2 are an example of the first theme selection step in which the first scene information is selected, the first scene information being provided to create the composite video output by the first output device in accordance with the instruction input from the first input device. Steps S3, S4 are an example of a theme association and change step, in which the scene information corresponding to the selected first scene information is selected as the second scene information creating the composite video output by the second output device. Steps S5, S6 are an example of the second theme selection step in which the second scene information is selected, the second scene information being provided to create the composite video output by the second output device in accordance with the instruction input from the second input device. Step S22 is an example of the first bank obtaining step in which the first bank selected via the first input device is obtained. Step S32 is an example of the second bank obtaining step in which the second bank selected via the second input device is obtained. Step S23 is an example of the first display step in which display is for setting the composite video output by the first output device in the first display region. Step S33 is an example of the second display step in which display is performed for setting the composite video output by the second output device in the second display region different from the first display region.

In the embodiment, in the theme association and change step, in the case where the second scene information for creating the composite video output by the second output device is selected, the first scene information for creating the composite video output by the first output device is maintained. The first theme selection step is a step that selects the scene information in accordance with the instruction input from the first input part from the bank obtained by the first bank obtaining means of the bank storage means. The theme association and change step is a step that obtains, from the second bank, the scene information stored in the same order as the first scene information selected from the first bank and changes the scene information to be the second scene information creating the composite video output by the second output device.

What is claimed is:

1. A video processing device, outputting a composite video,
wherein the composite video is a video in which a plurality of media data are disposed,
the media data is formed by an image and/or a video,
the video processing device comprises:
a first output device, outputting the composite video;
a second output device, outputting a composite video different from the composite video output by the first output device;
at least one processor; and
at least one display device, having a first display region and a second display region different from the first display region,
wherein the at least one processor is configured to:
perform display for setting the composite video output by the first output device in the first display region, and
perform display for setting the composite video output by the second output device in the second display region.

2. The video processing device as claimed in claim 1, wherein a plurality of scene information for forming the composite videos from the media data are provided,
the composite videos are created based on the media data and the scene information, and
wherein the at least one processor is configured to:
select first scene information for creating the composite video output by the first output device in accordance with an instruction input from the first input device, and
select second scene information for creating the composite video output by the second output device in accordance with an instruction input from the second input device.

3. The video processing device as claimed in claim 2, wherein the at least one processor is configured to:
select scene information corresponding to the selected first scene information as the second scene information for creating the composite video output by the second output device.

4. The video processing device as claimed in claim 3, wherein the at least one processor is configured to maintain the first scene information for creating the composite video output by the first output device in a case where the second scene information for creating the composite video output by the second output device is selected.

5. The video processing device as claimed in claim 3, further comprising a memory for storing a bank data in which a plurality of banks are stored, each of the banks storing a plurality of scene information in a predetermined order according to contents thereof,
wherein the at least one processor is configured to:
obtain a first bank selected via the first input device,
select, from the first bank, the first scene information in accordance with the instruction input from the first input device,
obtain a second bank selected via the second input device, and
obtain, from the second bank, scene information stored in an order same as the first scene information selected from the first bank, and change the scene information to be the second scene information for creating the composite video output by the second output device.

6. The video processing device as claimed in claim 4, further comprising a memory for storing a bank data in which a plurality of banks are stored, each of the banks storing a plurality of scene information in a predetermined order according to contents thereof,
wherein the at least one processor is configured to:
obtain a first bank selected via the first input device,
select, from the first bank, the first scene information in accordance with the instruction input from the first input device,
obtain a second bank selected via the second input device, and
obtain, from the second bank, scene information stored in an order same as the first scene information selected from the first bank, and change the scene information to be the second scene information for creating the composite video output by the second output device.

7. The video processing device as claimed in claim 2, wherein the first input device or the second input device is formed by a touch panel disposed on the first display region or the second display region.

8. The video processing device as claimed in claim 3, wherein the first input device or the second input device is formed by a touch panel disposed on the first display device or the second display device.

9. The video processing device as claimed in claim 4, wherein the first input device or the second input device is formed by a touch panel disposed on the first display device or the second display device.

10. A computer-readable recording medium, storing a video processing program that causes a computer to execute a process for outputting a composite video,
wherein the computer comprises a first output device, a second output device, and at least one display device,
the composite video is a video in which a plurality of media data are disposed,
the media data is formed by an image and/or a video,
the at least one display device has a first display region and a second display region different from the first display region,
the first output device outputs the composite video,
the second output device outputs a composite video different from the composite video output by the first output device,
the video processing program causes the computer to:
perform display for setting the composite video output by the first output device in the first display region, and
perform display for setting the composite video output by the second output device in the second display region different from the first display region.

11. The computer-readable recording medium as claimed in claim 10, wherein a plurality of scene information for forming the composite videos from the media data are provided,
the composite videos are created based on the media data and the scene information, and
the video processing program causes the computer to:
select first scene information for creating the composite video output by the first output device in accordance with an instruction input from the first input device, and
select second scene information for creating the composite video output by the second output device in accordance with an instruction input from the second input device.

12. The computer-readable recording medium as claimed in claim 11, wherein the video processing program causes the computer to select scene information corresponding to the selected first scene information as the second scene information for creating the composite video output by the second output device.

13. The computer-readable recording medium as claimed in claim 12, wherein in a case where the second scene information for creating the composite video output by the second output device is selected, the first scene information for creating the composite video output by the first output device is maintained.

14. The computer-readable recording medium as claimed in claim 12, wherein the computer further comprises a memory for storing a bank data in which a plurality of banks are stored, each of the banks storing a plurality of scene information in a predetermined order according to contents thereof,
the video processing program causes the computer to:
obtain a first bank selected via the first input device,
select, from the first bank, the first scene information in accordance with the instruction input from the first input device,
obtain a second bank selected via the second input device, and
obtain, from the second bank, scene information stored in an order same as the first scene information selected from the first bank, and change the scene information to be the second scene information for creating the composite video output by the second output device.

15. The computer-readable recording medium as claimed in claim 11, wherein the first input device or the second input device is formed by a touch panel disposed on the first display device or the second display device.

16. A video processing method, outputting a composite video,
wherein the composite video is a video in which a plurality of media data are disposed,
the media data is formed by an image and/or a video, and the video processing method comprising:
outputting the composite video by using a first output device;
outputting a composite video different from the composite video output by the first output device by using a second output device;
performing display for setting the composite video output by the first output device in a first display region; and
performing display for setting the composite video output by the second output device in the second display region different from the first display region.

17. The video processing method as claimed in claim 16, wherein a plurality of scene information for forming the composite videos from the media data are provided,
the composite videos are created based on the media data and the scene information, and
the video processing method comprises:
selecting first scene information for creating the composite video output by the first output device in accordance with an instruction input from a first input device, and
selecting second scene information for creating the composite video output by the second output device in accordance with an instruction input from a second input device.

18. The video processing method as claimed in claim 17, comprising: selecting scene information corresponding to the selected first scene information as the second scene information for creating the composite video output by the second output device.

19. The video processing method as claimed in claim 18, comprising: maintaining the first scene information for creating the composite video output by the first output device in a case where the second scene information for creating the composite video output by the second output device is selected.

20. The video processing method as claimed in claim 18, further comprising: storing a bank data in which a plurality of banks are stored, each of the banks storing a plurality of scene information in a predetermined order according to contents thereof by using a memory;
obtaining a first bank selected via the first input device,
selecting, from the first bank, the first scene information in accordance with the instruction input from the first input device,
obtaining a second bank selected via the second input device, and
obtaining, from the second bank, scene information stored in an order same as the first scene information selected from the first bank, and changing the scene information to be the second scene information for creating the composite video output by the second output device.
